(19) United States
(12) Patent Application Publication
(10) Pub. No.: US 2007/0186167 A1
(43) Pub. Date: Aug. 9, 2007

(54) Creation of a sequence of electronic presentation slides

(76) Inventor: Kent R. Anderson, Westborough, MA (US)

Correspondence Address: FISH & RICHARDSON PC, P.O. BOX 1022, MINNEAPOLIS, MN, 55440-1022, US

(21) Appl. No.: 11/348,429

(22) Filed: Feb. 6, 2006

(51) Int. Cl. G06F 3/00; G06F 17/30; G06F 7/00

(52) U.S. Cl. 715/730; 707/1; 707/100; 715/731; 715/732

(57) ABSTRACT

From a digitally stored body of items that are related in subject matter and together comprise a work, a subset of the items is automatically selected that will be representative of the work, and a sequence of presentation slides is automatically created from the selected subset. Different versions of the work may be published in different media and sequences of presentation slides may be automatically generated from a subset of the content items for distribution to users of the published versions.

### BACKGROUND

This description relates to creation of a sequence of electronic presentation slides.

Such a sequence may be useful, for example, for a physician who wants to present to his colleagues information about a scholarly article found in a journal such as the New England Journal of Medicine (NEJM). The article may contain different items of content of different types, for example, text, images, and aids to the reader that may include abstracts and side bar notes. The article may be distributed in paper form or online through an Internet web site. The items that make up the article may be stored electronically in source files that are used by the publisher to produce both the online and printed versions.

Creating a sequence of slides that is useful in presenting such an article may be done by hand by scanning the paper version and electronically cutting and pasting from the scanned pages to slides of a PowerPoint presentation. Or the physician may avoid the scanning process by cutting and pasting directly from the website.

### SUMMARY

In a general aspect, from a digitally stored body of items that are related in subject matter and together comprise a work, subset of the items is automatically selected that will be representative of the work, and a sequence of presentation slides is automatically created from the selected subset.

Implementations may include one or more of the following features.

The selected items include at least one of tables, images, drawings, charts, animations, video segments, audio segments, or graphs. The selected items include text. The selecting is based on information identifying at least one of: types of the items, patterns in punctuation or other common characteristics, or roles of the items in the work. The creating includes generating a PowerPoint-compatible file of the sequence. The creating includes generating a control file. One or both of the selecting and creating are done in connection with a publication of a version of the work and prior to a time when a user needs the sequence of presentation slides. One or both of the selecting and creating are done in response to a request of a user. The request of the user is received electronically. The request is received in response to serving of a webpage or link that contains a portion of the work. The work comprises a scholarly article. The sequence is delivered electronically to a user. From other digitally stored bodies of items that are related in subject matter and together comprise other works, subsets of the items are automatically selected that will be representative of the other works, and automatically creating sequences of presentation slides from the selected subsets.

In a general aspect, from a digitally stored body of content items that are related in subject matter and together comprise a work, different versions of the work are published in different media and sequences of presentation slides are automatically generated from a subset of the content items for distribution to users of the published versions.

Other aspects include the above and other features alone and in other combinations, expressed as methods, systems, apparatus, and program products and in other ways.

Other advantages and features will become apparent from the following description and from the claims.

### DESCRIPTION

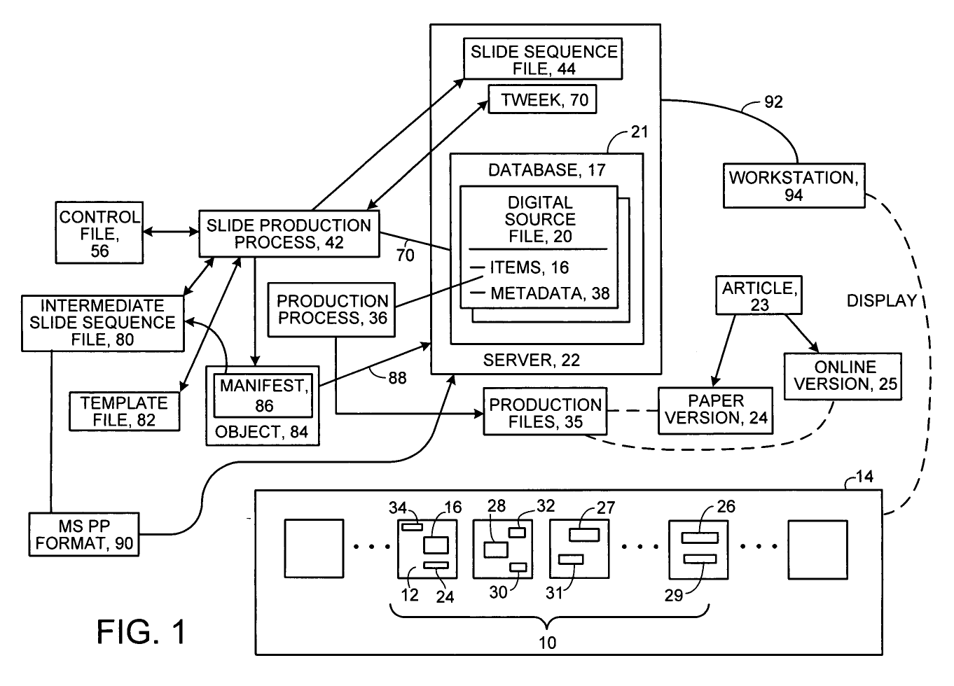

FIG. 1 is a block diagram.

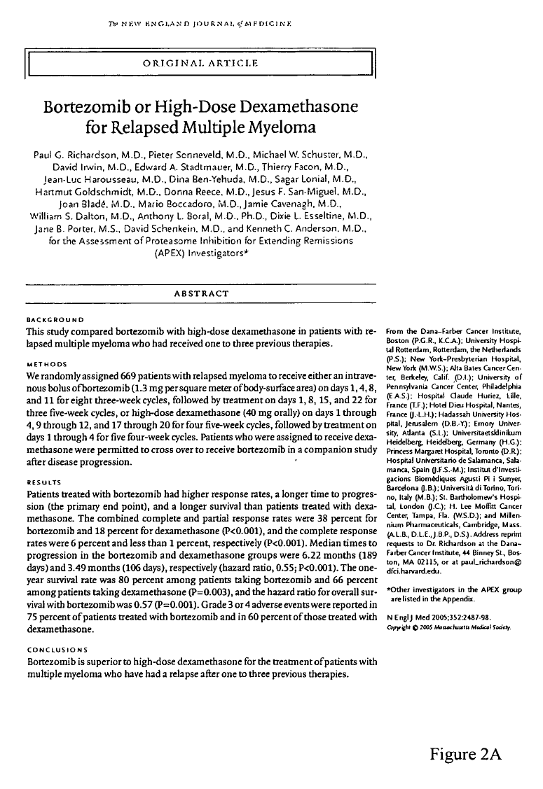

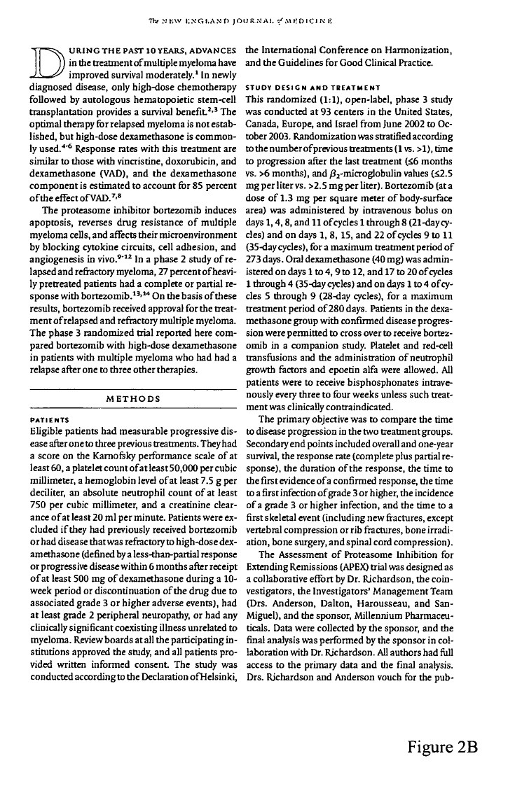

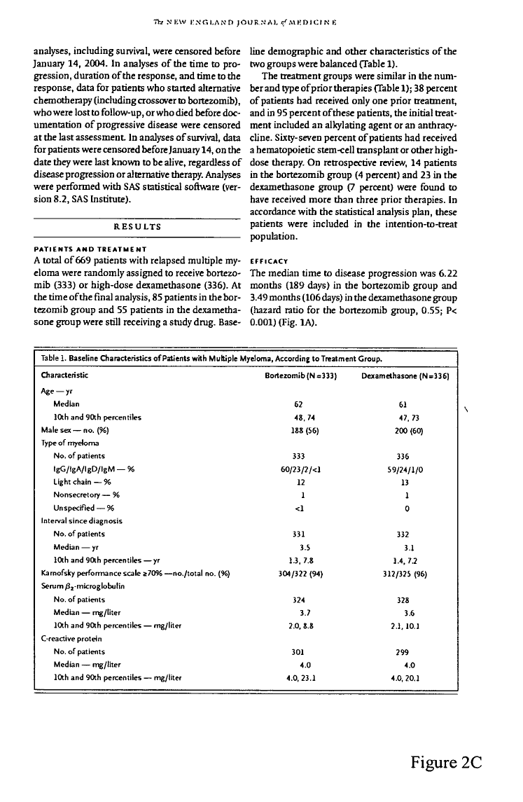

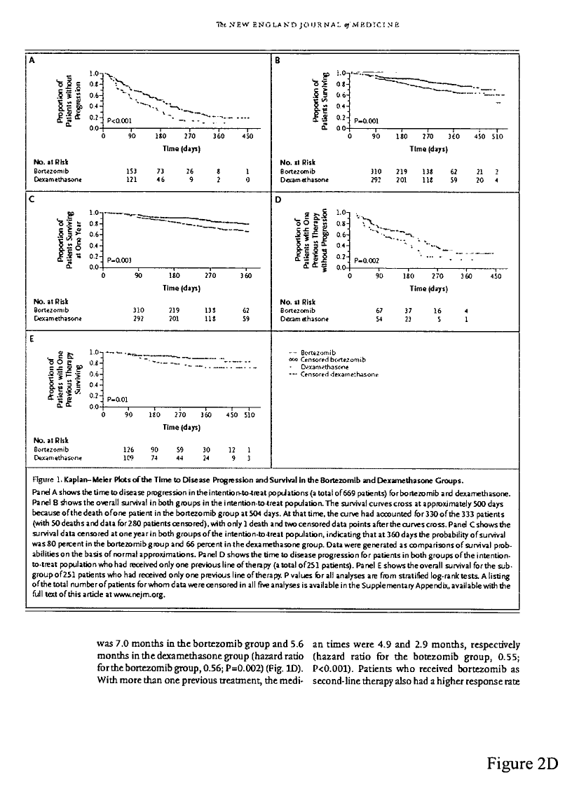

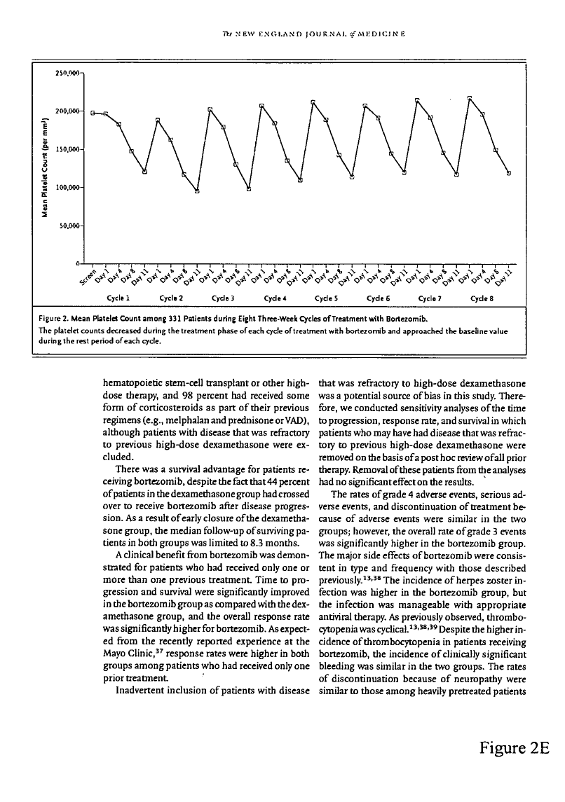

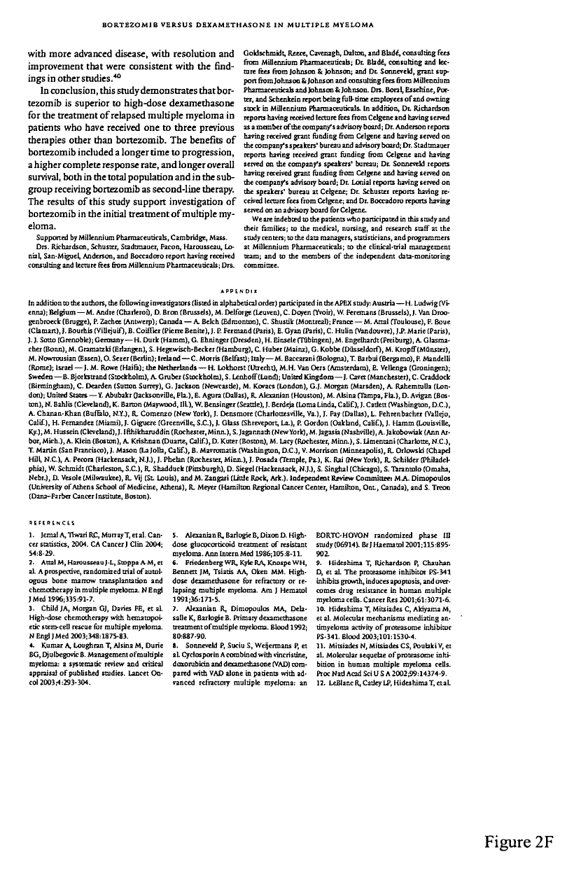

FIGS. 2A through 2F show pages of an article.

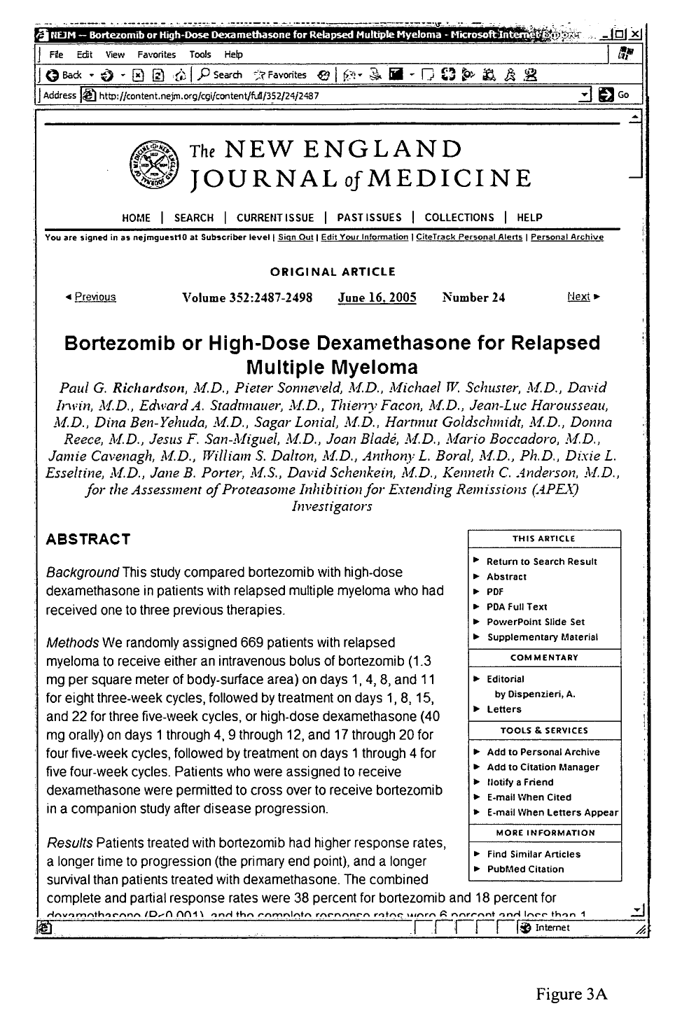

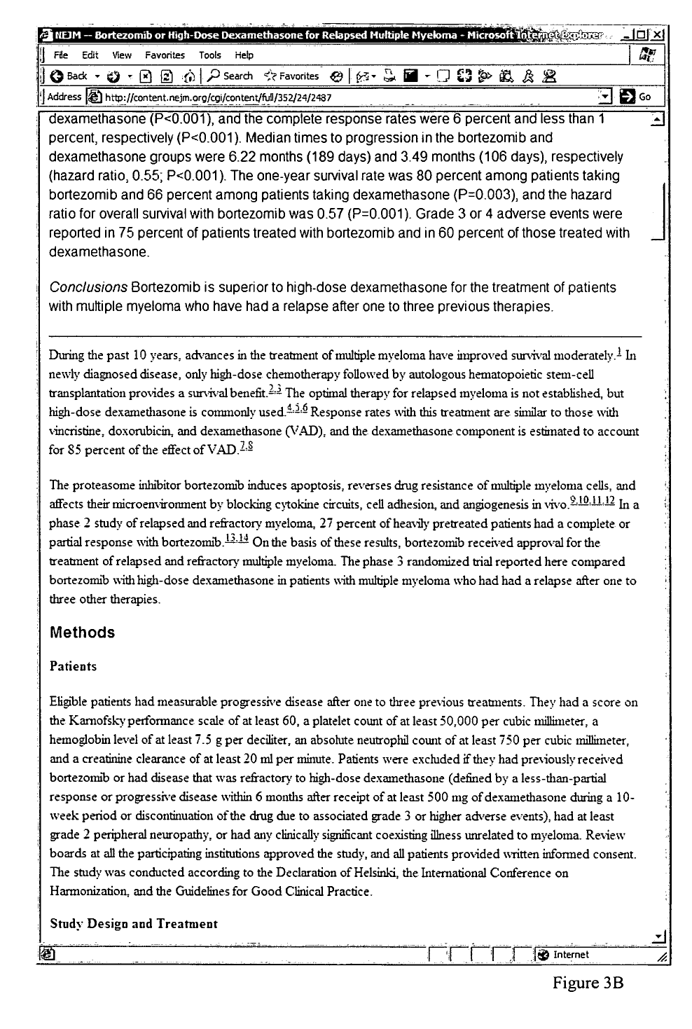

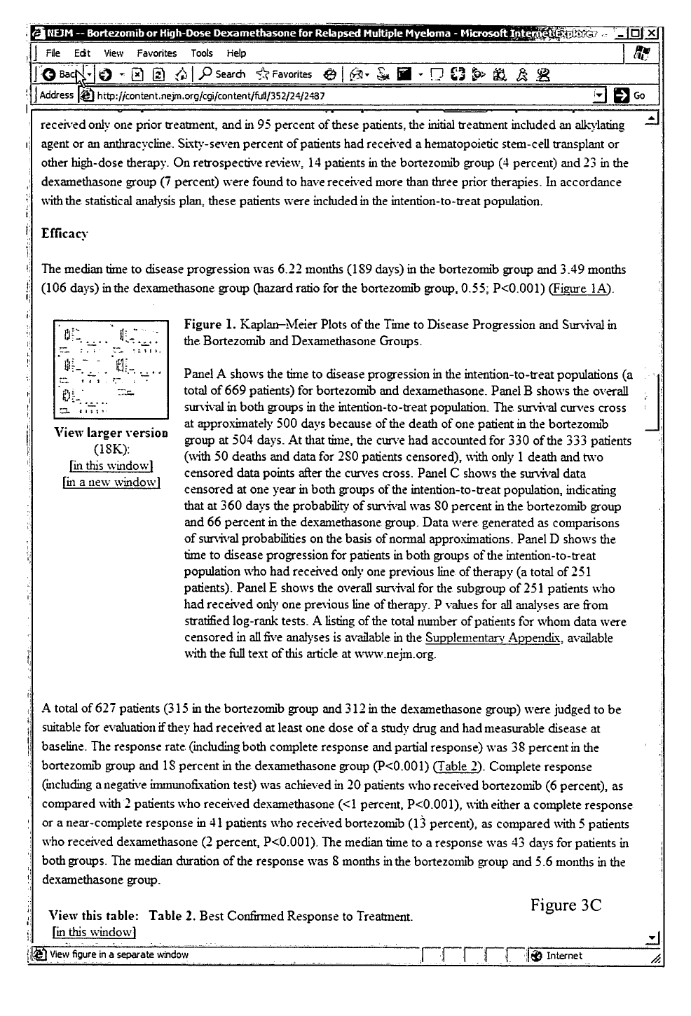

FIGS. 3a through 3C are screen shots of web pages related to the article.

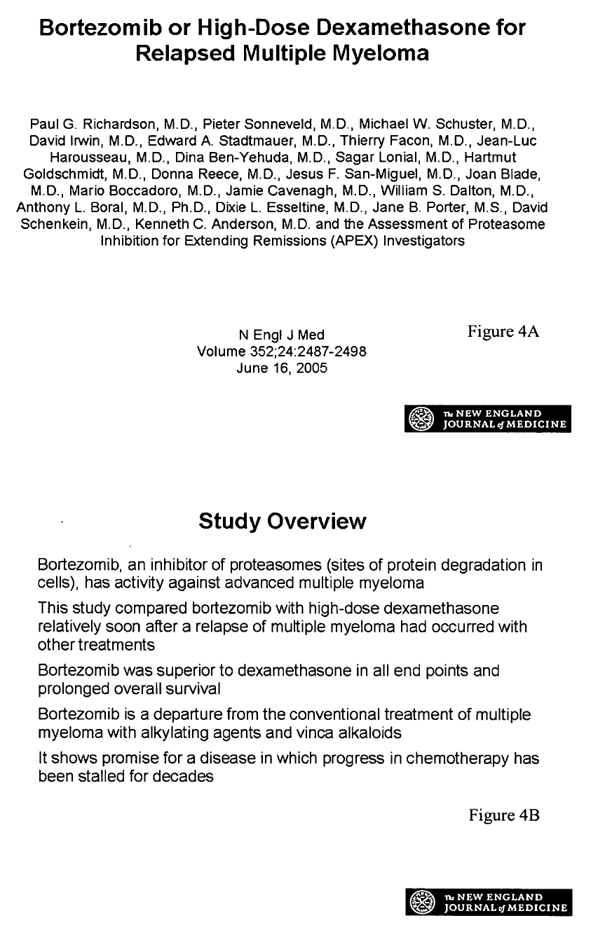

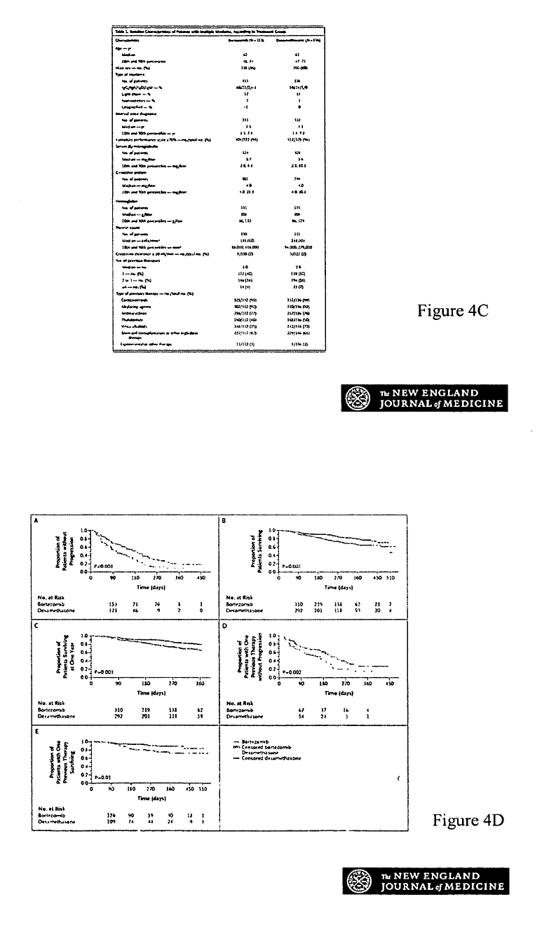

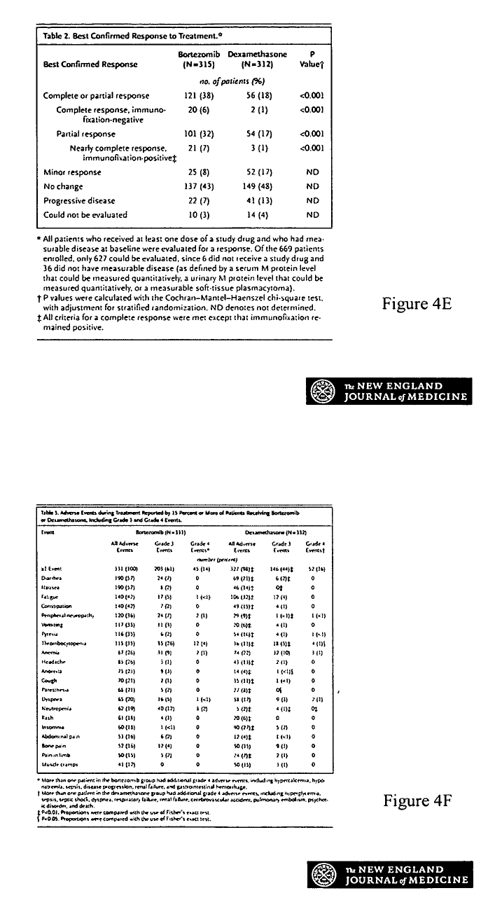

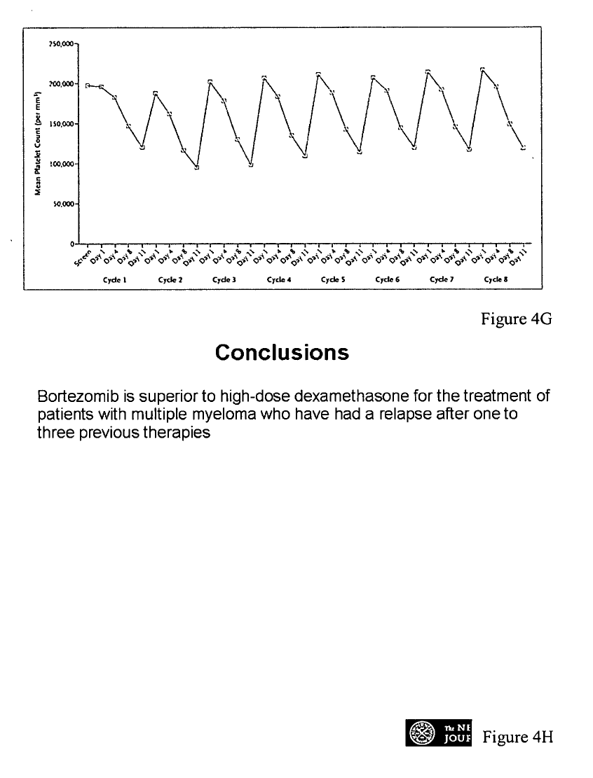

FIGS. 4A through 4H show presentation slides related to the article.

As shown in FIG. 1, we describe, as one example of a wide range of implementations, the automatic creation of a sequence 10 of slides 12 that can be used as or incorporated into a PowerPoint presentation 14. The sequence of slides contains items 16 of content 18 that are drawn from versions of those items that have been stored in an organized way in a digital source file 20 (one of a set 21 of source files) maintained on a server 22. All of the items in a particular digital source file may relate to a single article or work 23 (for example, an article of the NEJM) that is to be published in a paper version 24, in a website version 25, or possibly in other ways.

The digital source file is part of a larger article database 17 that contains many digital source files, for example, source files for all of the NEJM articles.

The items 16 of content include text 24 (body text, headings, titles, abstracts, summaries, sidebars, for example) and may contain other content, including images 26, tables 27, animations 28, charts 29, drawings 30, video segments 31, audio segments, dynamic objects 33, and headings 34. The items 16 may be re-used for different publication tasks, for example, to generate production files 35 used to publish the paper versions, or the website versions, to generate off-prints, and to produce marketing literature. Depending on the ultimate product being created, not all items may be used (for example, an animation could be used on a website but not on paper) and the order, arrangement, configuration, design, and placement of the different items may vary. A production process 36 may be run that can automatically fetch the relevant items for a given product and assemble them in a format and style that conforms to rules associated with that product. The production process can provide that capability with respect to a particular product (such as a paper version of the paper) or for a selectable set of different products.

Metadata 38 is also stored with or associated with the items to identify the type of the item (text, image, animation, for example), its role in the article (summary, abstract, body text, for example), its size, its relationship to other items, and other information useful in maintaining the digital source file and in creating products from the metadata. In a simple example, the metadata of the digital source file may include, for example, citation metadata information for the article (volume, issue, page, section_id), author metadata (first_name, last_name), and figure metadata (view type and disk location).

When the digital source file is one that contains a set of different articles that use similar types of items that have similar roles in the respective articles, it is possible for the production process to take advantage of the common features of the different articles to automate, at least to some extent, the process of assembling a paper version or an on-line version of the article. For example, if it is known that a particular item is an abstract, the process can automatically fetch and place the abstract item in the proper place in whatever product is in production.

The items and metadata included in the digital source file are provided, edited, maintained, and used, for example, by authors of the article, by editors, and by production workers.

In the particular example discussed here, the slide sequence contains versions of items (in particular, drawings, illustrations, tables, images, and figures) from Original Articles in the NEJM and from a feature called “This Week in the Journal”. An example of selected pages of such an article are shown in FIGS. 2A through 2F. Screen shots of portions of a corresponding website version of the article is shown in FIGS. 3A through 3C. The related slide sequence is shown in FIGS. 4A through 4H. Often, of course, the slides in the desired sequence are slides of visual items that can form the background for an oral presentation of the textual substance of an article rather than slides of the text itself. In any case, the slides to be included in the sequence typically represent a much smaller set of items from the digital source file than might be used in a paper or on-line version of the same article. In addition, the choice of which items to select from the digital source file and include in the slide sequence can be automated to the extent that the types and roles of items in the digital source file are known in advance. Thus, the production of the slide sequence can be largely automated for a large range of different articles that are stored in the database.

A slide sequence may be generated from the digital source file using a slide production process 42. The slide sequence may be created ahead of the time when it is needed by the user, during the process of producing the paper or on-line version of the article and then stored on the server as a slide sequence file 44, or may be generated dynamically upon invocation of a button or other control on the website by a user. For example, the page that presents the article on the website can include a button labeled “create and download slide sequence” as shown in FIG. 2. Other techniques, including on-line techniques, or email, could be used to enable the user to request a slide sequence for a given article. The identity of the article for which the sequence is requested must somehow be included in or associated with the article.

In some implementations, the user may simply indicate that he wants a slide sequence and a slide sequence is then created and returned to him. In some implementations, the user may be given a chance to control or indicate preferences with respect to the slide sequence to be created. For example, the user might be asked whether he wants a comprehensive slide sequence or a shortened sequence, or might be asked whether he wants the slides to include summary text or only visual items. In some cases, the user may be permitted to specify preferences on the layout, design, colors, and other features of the sequence. The user interface for requesting the slides is configured appropriately to permit no options, or any of the described (or other) options for the user.

As explained earlier, the slide sequence to be created is likely to be used as an aid to an oral presentation of the content of the article. For that reason, the images, text, and other items to be included in the slide sequence may be a subset of items compared to the paper or online article, and the items may appear in a different order and a different arrangement in the slide sequence than in the paper or on-line version. Because the types and roles of the items are identified and the format, layout, and presentation of various articles are similar (even though they differ in content), it is possible to define a process that automatically identifies the items of a typical article that should be fetched and included in the slide sequence and the order in which they should be presented.

In some cases, the digital source file (or at least the content portion of it) is in the form of an XML file. (The metadata portion may exist separately in the database 17.) Appendix A shows portions of the digital source XML file corresponding to the article of FIG. 2.

In preparation for creating the slide sequence of an article, the production process 38 automatically creates a control file 56 expressed in XML format. The control file describes the items contained in the slide sequence. The XML description in the control file is independent of the particular slide show application that will be used to present the slide sequence. For example, the control file may be used to generate a slide sequence that will later be used by Microsoft PowerPoint, or by any other of a variety of slide presentation applications. At a later stage in the process the application-independent slide sequence description is converted to the final form in which it can be used by a particular application. The use of an intermediate control file is also useful because it permits easy correction of, for example, heading text and item text if the automated text extraction performed by the slide production process from the digital source file is problematic.

To construct the control file for a particular article in a specific issue of the NEJM, for example, the slide production process must locate the stored items of the article in the server.

This is done by first finding unique resource identifiers (URIs) and file system paths of all article summaries (called “TWeek” here, in reference to “This Week in the Journal”) in the database 17. From the database, the unique resource identifiers and file system paths of all ‘Original Articles’ are found. A TWeek xml file 70 is parsed to find the <TWCallout> reference 72 to the article to be used. If the article is in the “Original Articles” section of the database, then both the TWeek information and the referenced article will be used for creating the slide sequence.

A <citation> element of the XML control file is constructed from metadata for the Original Article previously stored in the database 17. The citation element contains, for example, the following information: volume, issue, firstpage, lastpage, pubdate, article title, and list of authors. The resulting XML in the control file corresponds to a cover slide that shows the bibliographic information as in FIG. 4A.

Then, the XML for the first substantive <slide> is created having the <heading> ‘Study Overview’. A bullet list of items is constructed by using each sentence of the first paragraph in the TWeek summary XML as a bullet item. Correction for non-sentence period punctuation is also done at this stage (e.g., refraining from breaking “S. aureus” into two bullet items by following an algorithm that prevents a break when the period is preceded by a capital letter)

For the images or tables called out in the digital source XML file, XML in the control file is created for the corresponding <slide> s in the same order.

The <heading> XLM for each image or table slide is the figure caption or table caption as extracted from the digital source XML file.

The <image><path> is the location of, for example, a large JPEG image on the file system of the server 22.

The XML for the final <slide> is set up with a <heading> ‘Conclusion’. A bullet list of items is constructed by taking the first sentence of the Conclusions paragraph as tagged in the abstract item of the digital source XML file.

Next, an intermediate slide sequence file 80 is created and expressed in a compressed XML format (.sxi) using open-source software called OpenOffice. This XML format is documented in the OpenOffice.org XML File Format 1.0 Technical Specification. The intermediate slide sequence file is in platform neutral format for the generation of a slideshow presentation in a platform-neutral fashion The control file 56 and the high-resolution images (stored, for example, as .jpg files) are used to generate the .sxi presentation using a command-line Java program. For this purpose, the control file is parsed to build an in-memory object model (that is, the intermediate slide sequence file). This in-memory object model is then validated for correctness before proceeding.

A second .sxi file 82 serves as a template, providing definitions for static components of the presentation (e.g., New England Journal of Medicine logo), as well as needed Open Office presentation and text styles (e.g., size and font information).

Each slide in the sequence 14 is constructed from the control file in-memory object model 80. The items of the slide sequence are added to an object 84 that wraps a dynamically generated manifest. This manifest is used to create the .sxi file using Zip compression and callbacks to the in-memory slide objects themselves.

The .sxi slide sequence is then converted to Microsoft PowerPoint (PPT) format using OpenOffice 1.1. The resulting PowerPoint file is placed in an appropriate location on the file system of the server 22 and the location associated with the slide sequence view placed in the database 17.

Standard runtime system software then makes the PowerPoint slide sequence for the article available 92 to a user's workstation 94 when accessed through the content.nejm.org website, subject to subscription access control. The content is served through a special servlet, which provides the appropriate access control barriers, service logging and handshaking with the client browser.

Once the slide sequence has been downloaded to a user, in some implementations the user can supplement it and edit it by adding, subtracting or modifying the sequence. In some implementations, the user is constrained from making changes to the downloaded sequence.

In cases in which the item to be included in the slide sequence is an animation, the animation may be handled as a flash object using a technique described in a patent application being filed on the same day as this application and entitled CREATION AND USE OF AN ELECTRONIC PRESENTATION SLIDE THAT INCLUDES MULTIMEDIA CONTENT, which is incorporated here by reference.

Other implementations are within the scope of the following claims. For example, the source from which the slide sequence presentation is automatically created need not relate to a journal article but could be any kind of content.

1. A method comprising
from a digitally stored body of items that are related in subject matter and together comprise a work, automatically selecting a subset of the items that will be representative of the work, and
automatically creating a sequence of presentation slides from the selected subset.

2. The method of claim 1 in which the selected items include at least one of tables, images, drawings, charts, animations, video segments, audio segments, or graphs.

3. The method of claim 1 in which the selected items include text.

4. The method of claim 1 in which the selecting is based on information identifying at least one of: types of the items, patterns in punctuation or other common characteristics, or roles of the items in the work,

5. The method of claim 1 in which the creating includes generating a PowerPoint-compatible file of the sequence.

6. The method of claim 1 in which the creating includes generating a control file.

7. The method of claim 1 in which one or both of the selecting and creating are done in connection with a publication of a version of the work and prior to a time when a user needs the sequence of presentation slides.

8. The method of claim 1 in which one or both of the selecting and creating are done in response to a request of a user.

9. The method of claim 1 in which the request of the user is received electronically.

10. The method of claim 9 in which the request is received in response to serving of a webpage that contains a portion of the work.

11. The method of claim 1 in which the work comprises a scholarly article.

12. The method of claim 1 also including delivering the sequence electronically to a user.

13. The method of claim 1 also including
from other digitally stored bodies of items that are related in subject matter and together comprise other works, automatically selecting subsets of the items that will be representative of the other works, and
automatically creating sequences of presentation slides from the selected subsets.

14. A medium bearing instructions to cause a device to
from a digitally stored body of content items that are related in subject matter and together comprise a work, automatically select a subset of the items that will be representative of the work, and
automatically create a sequence of presentation slides from the selected subset.

15. A method comprising
from a digitally stored body of content items that are related in subject matter and together comprise a work, publishing different versions of the work in different media and automatically generating sequences of presentation slides from a subset of the content items for distribution to users of the published versions.
